(19) United States
(12) Patent Application Publication
(10) Pub. No.: US 2016/0227956 A1
(43) Pub. Date: Aug. 11, 2016

(54) BREWING FILTER

(71) Applicant: 8479950 CANADA INC., Montréal (CA)

(72) Inventors: Edward Ko, Montreal (CA); Lisa Mac Innis, Candiac (CA); Dimitri Paraskevopoulos, Beaconsfield (CA); Warren Myers, Palm City, FL (US)

(73) Assignee: 8479950 Canada Inc., Montreal (CA)

(21) Appl. No.: 15/023,218

(22) PCT Filed: Sep. 19, 2014
(86) PCT No.: PCT/CA2014/050901

§ 371 Date: Mar. 18, 2016

Related U.S. Application Data
(60) Provisional application No. 61/880,355, filed on Sep. 20, 2013.

(51) Int. Cl. A47J 31/06; A47J 31/10

(52) U.S. Cl. CPC A47J 31/06; A47J 31/10

(57) ABSTRACT

A brewing filter includes a hollow, substantially funnel-shaped body defining therewithin a brewing cavity adapted to receive a brewing material. The body is at least partially formed by a perforated filter material. The body has a top portion defining an open top end and a bottom portion including a closed bottom end. The bottom portion and the top portion respectively define bottom and top lateral profiles. The bottom lateral profile is laterally recessed relative to the top lateral profile. A transition line located between the top and bottom portions forming a visually-identifiable demarcation within the brewing cavity.

### BACKGROUND

Conventional drip coffee machines work by pouring hot water on a certain amount of brewing material, such as ground coffee or tea, disposed in a filter. In the example of a coffee machine, a reservoir which holds the water needed for preparing the coffee, and a resistance inside the reservoir heats up the water. A fluidic connection transports the hot water to a location above the filter containing the coffee grounds so as to let the water drip thereon. The hot water mixes with the ground coffee thereby brewing it. The brewed coffee drips through the filter while the ground coffee remains inside the filter.

To make a cup of coffee, the user usually uses a scoop to transfer ground coffee to the filter. The scoop can hold a predetermined amount of ground coffee to make the cup. As such, the scoop can be the measuring device which allows the user to provide adequate amounts of coffee to the coffee maker. Sometimes, the user may lose the scoop and must then use a regular spoon. In doing so, the user has no more indication on how much ground coffee he/she needs to brew one cup of coffee. Additionally, whether the user has the measuring scoop or not he/she may not know how much coffee is needed for a carafe and may use more scoops than needed.

### BRIEF SUMMARY

In one aspect there is provided a brewing filter for a drip coffee machine comprising: a hollow, substantially funnel-shaped body defining therewithin a brewing cavity adapted to receive a brewing material the body being at least partially formed by a perforated filter material, the body having a top portion defining an open top end and a bottom portion including a closed bottom end; and the bottom portion and the top portion respectively defining bottom and top lateral profiles, the bottom lateral profile being laterally recessed relative to the top lateral profile, and a transition line located between the top and bottom portions forming a visually-identifiable demarcation within the brewing cavity.

In yet another aspect, there is provided a drip coffee machine comprising: a water module including: a water reservoir; and a heater heating adapted to heat water contained in the water reservoir; a brewing module in fluid connection with the water module, the brewing module including: a brewing filter including: a hollow, substantially funnel-shaped body defining therewithin a brewing cavity adapted to receive a brewing material, the body being at least partially formed by a perforated filter material, the body having a top portion defining an open top end and a bottom portion including a closed bottom end; and the bottom portion and the top portion respectively defining bottom and top lateral profiles, the bottom lateral profile being laterally recessed relative to the top lateral profile, and a transition line located between the top and bottom portions forming a visually-identifiable demarcation within the brewing cavity.

### BRIEF DESCRIPTION OF THE DRAWINGS

For a better understanding of the present, as well as other aspects, and further features thereof, reference is made to the following description which is to be used in conjunction with the accompanying drawings, where:

FIG. 1 is a perspective view of an embodiment of a coffee machine;

FIG. 2 is a perspective view of a filter for the coffee machine of FIG. 1 according to a one embodiment;

FIG. 3 is a top plan view of the brewing filter of FIG. 2;

FIG. 4 is a side elevation view of the brewing filter of FIG. 2;

FIG. 5 is a perspective view of a filter according to a second embodiment;

FIG. 6 is a side elevation view of the brewing filter of FIG. 5;

FIGS. 7A to 7D are side elevation view schematics of various embodiments of the brewing filters of FIG. 2 and 5;

FIG. 8 is an isometric cross-sectional view of an adapter according to a first embodiment disposed in a coffee filter;

FIG. 9 is a perspective exploded view of the adapter and coffee filter of FIG. 8;

FIG. 10 is a cross-sectional view of an adapter according to a second embodiment disposed in the coffee filter of FIG. 8;

FIG. 11 is a cross-sectional view of an adapter according to a third embodiment disposed in the coffee filter of FIG. 8;

FIG. 12 is a cross-sectional view of an adapter according to a fourth embodiment disposed in the coffee filter of FIG. 8; and

FIG. 13 is a cross-sectional view of an adapter according to a fourth embodiment disposed in the coffee filter of FIG. 8.

### DETAILED DESCRIPTION

Various embodiments of filters and adapters for niters for drip coffee makers will be disclosed below. The filters and adapters are adaptable to coffee makers that accepted a non-disposable filter. It is contemplated that the filters and adapters described herein could be adapted to brewing machines other than coffee machines. For example, the filters could be adapted to tea makers. Through this description, spatial orientations such as “top”, “bottom”, “sides” will be made with reference to a normal operating condition of the filter.

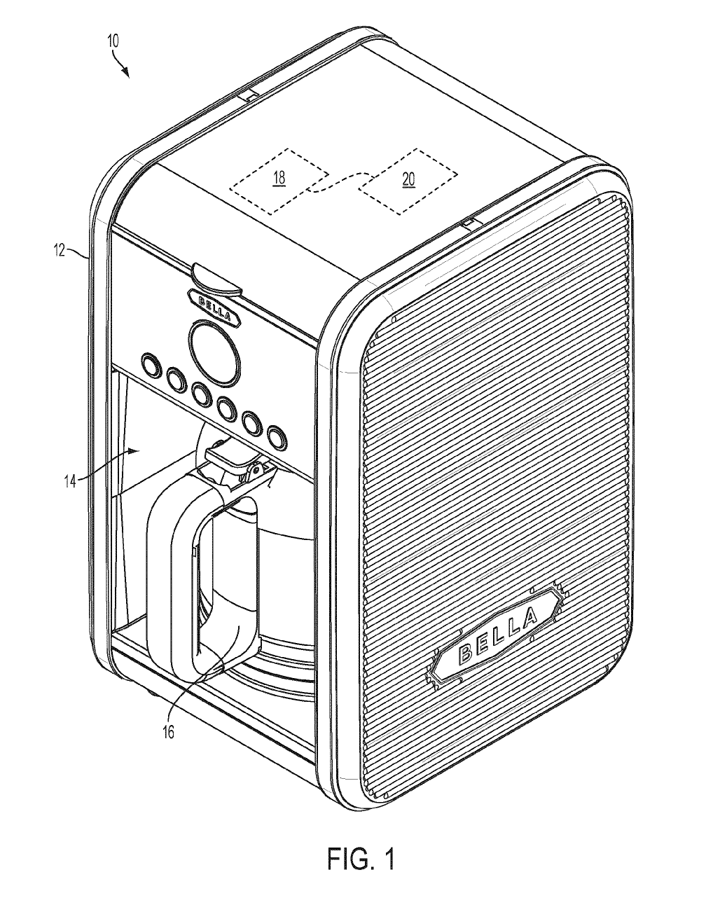

Referring to FIG. 1, a drop coffee machine 10 is illustrated as an embodiment of a brewer. The coffee machine 10 includes a housing 12 having a cavity 14 sized to accommodate a carafe 16. The coffee machine 10 may also accommodate a cup (not shown). Internally, the coffee filter 10 includes, among other things, a water module 18 (schematically shown) including a water reservoir (not shown) and a heating element (not shown) adapted to heat water contained in the water reservoir. The water module 18 is in fluid connection with a brewing module 20 (schematically shown) including a brewing filter as will be described below, which is adapted to receive coffee grounds. At least the brewing module 20, and its brewing filter, are disposed vertically above the carafe 16.

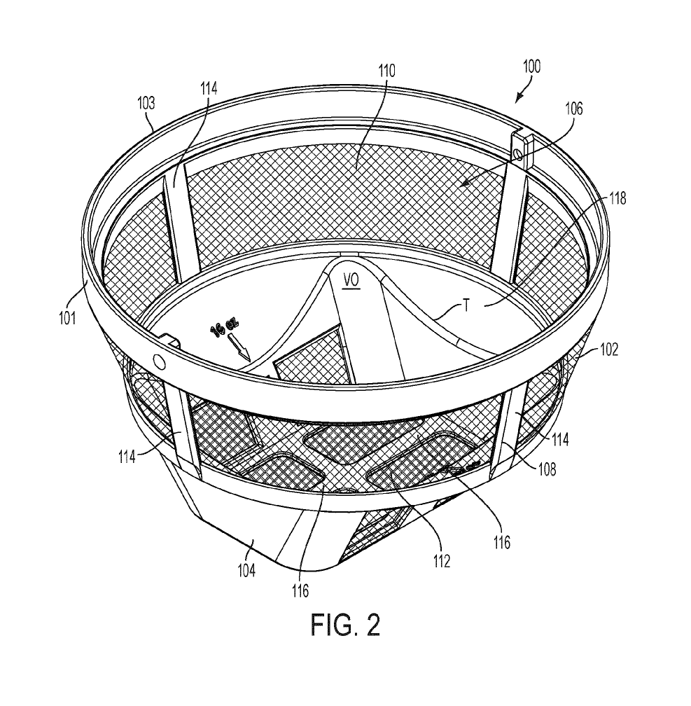

Referring to FIGS. 2 to 4, a first embodiment of a filter 100 for the drip coffee machine 10 will be described. The filter 100 may be removable from the drip coffee machine 10.

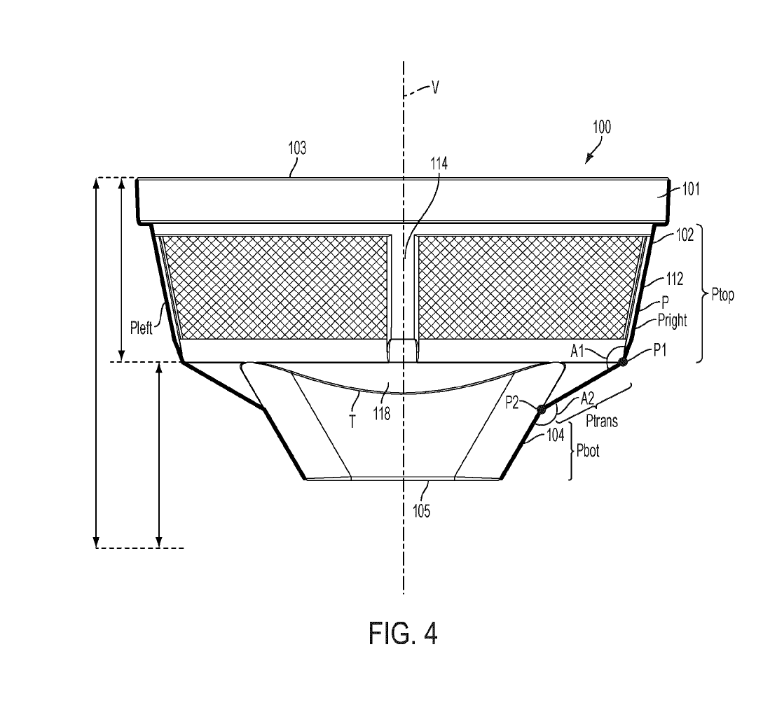

The filter 100 includes a hollow, substantially funnel-shaped body 101. The body 101 generally includes a top portion 102 having an open top end 103, and a bottom portion 104 having a closed bottom end 105 (shown in FIG. 4). When the filter 100 is disposed in the coffee machine 10, the top end 103 faces the water module 18. The top portion 102 and the bottom portion 104 define therewithin a brewing cavity 106 adapted to receive the brewing material. As will be seen, the bottom portion 104 is recessed relative to the top portion 102. The top and bottom portions 102 and 104 of the filter 100 meet at a vertical location (reference to vertical V in FIG. 4) disposed between the open top end 103 and the closed bottom end 105 which defines an intermediate transition line T. The intermediate transition line T defines the Intersection between the top and bottom portions 102 and 104 of the filter 100 and creates a visually-identifiable demarcation for the user. This demarcation can be used by the user to determine a volume of ground coffee that needs to be put in to obtain a desired volume of coffee smaller than a capacity of the filter 100 (e.g. a single cup).

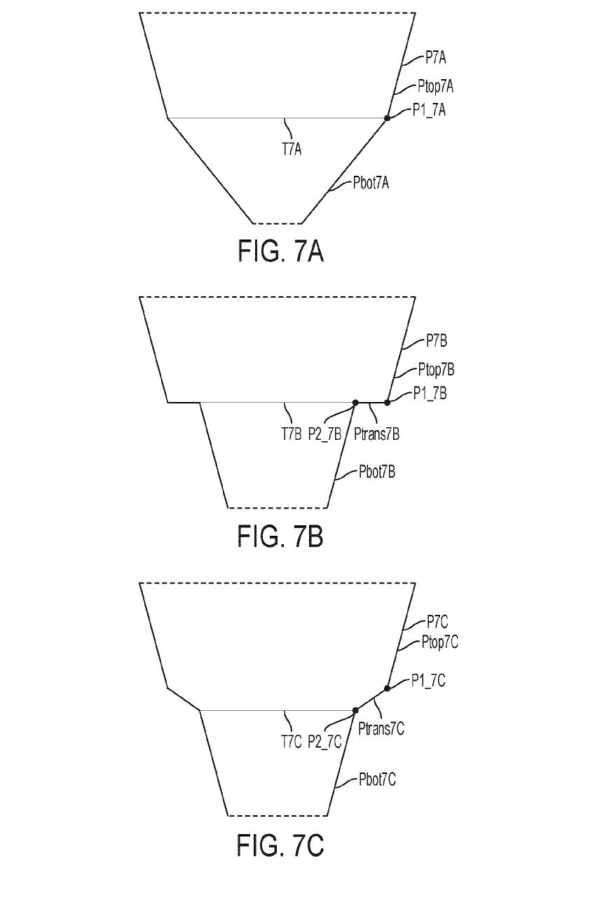

In this embodiment, the top portion 102 and the bottom portion 104 of the filter 100 have different shaped perimeters, or more specifically have different horizontal cross-sectional perimeters (or simply “perimeter”), which create the demacration. In this embodiment, for example, the top portion 102 has a generally circular perimeter and the bottom portion 104 has a generally square perimeter. It is contemplated that the top portion 102 and the bottom portion 104 could have a shape different from the one shown in the Figures. For example, the top portion 102 could be square and the bottom portion 104 could be circular. It is also contemplated that the top portion 102 and the bottom portion 104 could have the same shape as long as the bottom portion 104 is recessed relative to the top portion 102 so that a transition line between these two portions is visible by looking at the shape of the filter 100. An example of such embodiment of filter is shown in FIG. 7B.

The body 101 is made at least partially of a perforated filter material. In one embodiment, the body 101 is made of a frame 108 with various mesh portions covering windows defined in the frame 108. The frame 108 accepts a top mesh 110 extending on the top portion 102, and a bottom mesh 112 closing the bottom end 105. Although the filter 100 described herein includes a frame 108 and mesh 110, 112, it is contemplated that the mesh and frame could be integrally formed. In one embodiment, the frame 108 is made of plastic.

The top mesh 110 and the bottom mesh 112 are made of metal and have a pore or mesh size allowing water to flow therethrough but retaining ground coffee. It is contemplated that the top mesh 110 could be finer or more coarse than shown in the Figures, it is also contemplated that the top mesh 110 could be made of another suitable material. The top mesh 110 is supported by a plurality of reinforcement arms 114 of the frame 108 extending vertically on the top portion 102. As best shown in FIG. 4, the reinforcement arms 114 are inclined slightly outwardly to give the filter 100 a generally tapered appearance (i.e. funnel shaped) and favour water dripping toward the bottom end 105. It is contemplated that the reinforcement arms 114 could be more or less inclined than shown in the Figures, thereby imparting a more or less taper to the filter 100. It is also contemplated that the frame 108 could have more or less reinforcement arms 114 than shown in the Figures. It is also contemplated that the reinforcement arms 114 could extend only partially from the top portion 102 to the bottom portion 104. For example, the reinforcement arms 114 could extend from only one of the top portion 102 and the bottom portion 104 without reaching the other one of the top portion 102 and the bottom portion 104.

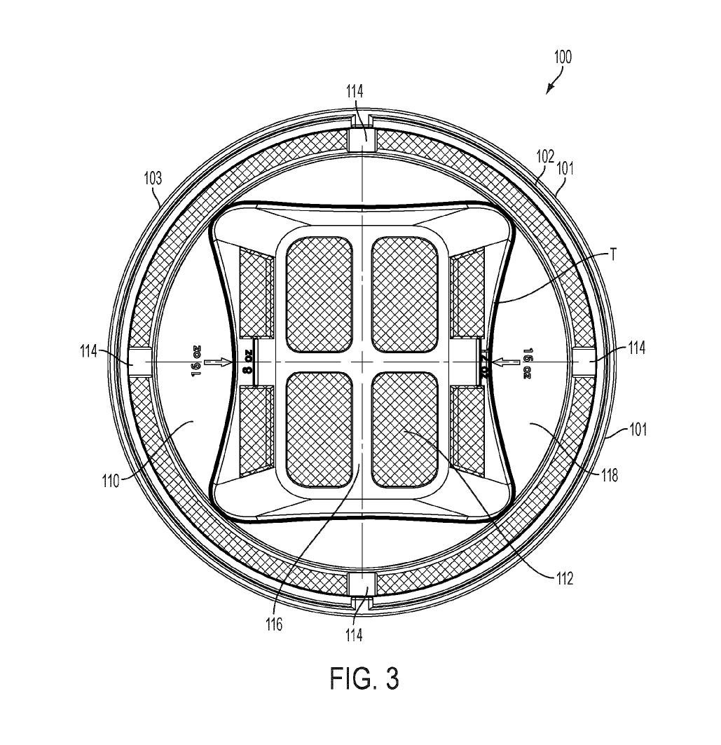

The bottom mesh 112 is supported by four reinforcement arms 116. The reinforcement arms 116 are extending horizontally across the bottom end 105. The reinforcement arms 118 are joining each other at a center of the bottom end 105 so as to form a X-shape, shown best in FIG. 3. It is contemplated that the frame 108 could have only more or less than four reinforcement arms 116. If is also contemplated that the reinforcement arms 116 could form shapes other than a X-shape. For example, the reinforcement arms 116 could be forming a Y-shape.

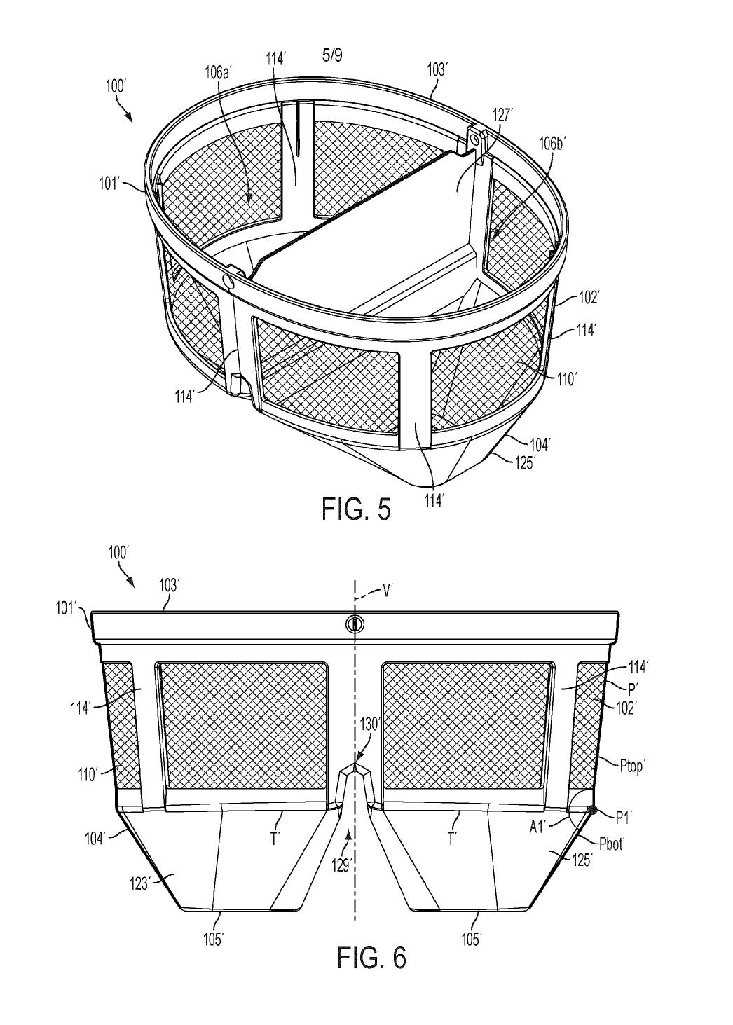

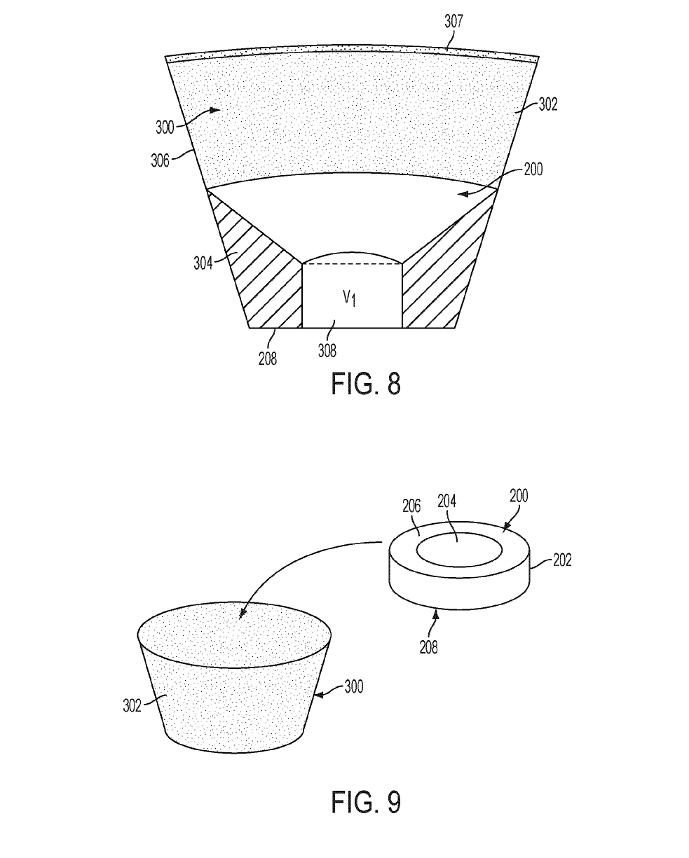

A transition portion 118 is disposed between the bottom portion 104 and the top portion 102. The transition line T separates the transition portion 118 from the bottom portion 104 and defines an upper limit of the bottom portion 104. The transition line T is shown in bold in FIG. 3 for ease of identification. The transition portion 118 allows a smooth transition between the top portion 102 and the bottom portion 104, because of their different perimeter shapes and size creating the recess of the bottom portion 104 relative to the top portion 102. If is contemplated that the transition portion 118 could be omitted. An example of such filter is shown and described below with respect to FIGS. 5 and 8.

Referring more specifically to FIG. 4, the filter 100 has a lateral profile P (illustrated by a thick black line). The lateral profile P is a line drawn from a profile or silhouette of a side of the filter 100. The lateral profile P is determined on the filter 100 as seen in a normal operating condition, such as the side elevation view in FIG. 4. The lateral profile P is an indication that the bottom portion 104 is recessed r elative to the top portion 102.

For any orientation of the filter 100 about a vertical axis V, the fitter 100 has two lateral profiles, a left one Pleft and a right one Pright. While the lateral profile P is shown herein to have symmetric left and right sides Pleft, Pright for different orientations of the filter 100, it is contemplated that the fitter 100 could have only one side with the lateral profile P having a variable slope.

The lateral profile P, in this embodiment, includes a top portion Ptop, a transition portion Ptrans, and a bottom portion Pbot. The lateral profile P has a slope that undergoes at least one distinct change from the top end 103 to the bottom end 105, due to the recess of the bottom portion 104. Slopes of the top portion Ptop, the transition portion Ptrans, and the bottom portion Pbot are in this embodiment generally constant, and the lateral profile P is characterised by two slope changes (called herein “inflection points”) at points P1 and P2 which correspond to connections between the top portion 102, transition portion 118, and bottom portion 104. The inflection point at point P2 corresponds to the transition line T discussed earlier

It is contemplated that the lateral profile P could have only one or more than two inflection points. The inflection points are induced by a change of perimeter shape in the filter 100. In the example shown herein, the inflection point P1 or P2 virtually delimits the filter 100 into the top portion 102 and the bottom portion 104. It is contemplated that one of the inflection point P1 and P2 could be omitted, in which case there would not be any transition portion Ptrans. The changes of slopes in the lateral profile P can also be characterised by transition angles. In the example shown in FIG. 2 to 4, a transition angle A1 is defined between the top portion Ptop and the transition portion Ptrans of the lateral profile P, and a transition angle A2 is defined between the transition portion Ptrans and the bottom portion Pbot of the lateral profile P. Should the transition portion 118 be omitted, a transition angle would be defined between the top portion Ptop and the bottom portion Pbot. It is contemplated that one or some or all of the top portion Ptop, the transition portion Ptrans, and the bottom portion Pbot could be curved and that the slope may be identified as the tangent to the curve at the connection points between the portions Ptop, Ptrans, and Pbot.

As best seen in FIG. 4, the top portion Ptop and the bottom portion Pbot are laterally inwardly tapered and define a non-zero slope. In this embodiment, the slope of the bottom portion Pbot is steeper than the slope of the top portion Ptop, but it is contemplated that the top portion Ptop and the bottom portion Pbot could have various slopes with for example the top portion Ptop steeper than the bottom portion Pbot. If is also contemplated that the top portion Plop and the bottom portion Pbot could have a same slope and the transition portion Ptrans with a different slope to enable visual identification of the bottom portion 104, since the bottom portion 104 would appear recessed relative to the top portion 102.

The lateral profile P may have at least one slope change (i.e. inflection point) which indicates the recess of the bottom portion 104. FIGS. 7A to 7C show examples of filters (schematically shown) which profiles indicate such recess of the bottom portion and a transition line.

In FIG. 7A, a profile P7A has a top portion Ptop7A having a first slope, and a bottom portion Pbot7A having a different slope thereby creating a transition line T7A at the inflection point P1_7A. As a result, the bottom portion Pbot7A is recessed from the top portion Ptop7A.

In FIG. 7B, a profile P7B has a top portion Ptop7B having a same slope as a bottom portion Pbot7B, but a transition portion Ptrans7B recesses the bottom portion Pbot78 from the top portion Ptop7B. In this example, the transition portion Ptrans7B is horizontal, but the transition portion Ptrans7B could have a different slope. Inflection points P1_7B and P2_7B join the bottom portion Pbot7B and the top portion Ptop7B to the transition portion Ptrans7B. A transition fine T7B is visible between the transition portion Ptrans7B and the bottom portion Pbot7B at the inflection point P2_7B.

In FIG. 7C, a profile P7C has a top portion Ptop7C having a first slope and a bottom portion Pbot7C having a different second slope with a transition portion Ptrans7C recessing the bottom portion Pbot7C from the top portion Ptop7C. In this example, the transition portion Ptrans7C has a third different slope. The transition portion Ptrans7C could be horizontal or have a same slope as one of the top portion Ptop7C and the bottom portion Pbot7C. Inflection points P1_7C and P2_7C join the bottom portion Pbot7C and the top portion Ptop7C to the transition portion Ptrans7C. A transition line T7C is visible between the transition portion Ptrans7C and the bottom portion Pbot7C at the inflection point P2_7C.

The bottom portion 104 is sized to have a volume V0 corresponding to a predetermined volume of ground coffee. In the embodiment shown in the Figures the volume V0 correspond to a single cup serving. Because of the change of perimeter shape between the circular top portion 102 and the generally squared bottom portion 104 as well as the presence of the transition line T, the user easily recognizes what volume of the filter 100 needs to be filled ground coffee to obtain a single cup of coffee. As a result, the user does not need to use a scoop that can hold a predetermined amount of ground coffee to transfer ground coffee to the filter 100. The user can just transfer coffee with a regular spoon to the filter 100 and fill the bottom portion 104 of ground coffee with the assurance that he/she will obtain a single serving of coffee. Should the user wanted a larger amount of coffee, for example, for the carafe 16, the user would then continue to fill the filter 100 with ground coffee. In one example, the filter 100 holds enough ground coffee to brew the carafe 16 of coffee. It is contemplated that the volume of ground coffee held by the bottom portion 104 could correspond to amounts of coffee that will be other than a single cup of coffee. For example, the bottom portion 104 could hold ground coffee for two cups of coffee. Similarly, the filter 100 may hold more or less than coffee for making a carafe of coffee.

Although the filter 100 is shown herein to have only one portion (i.e. bottom portion 104) having a volume corresponding to a predetermined volume of coffee (i.e. volume V0), it is contemplated that the filter 100 could have two or more of such portions, vertically stacked, and as a result more than two changes of direction P1, P2. For example, the filter 100 could have a lower portion of the frame 108 having a first shape could have a first volume corresponding to a single cup of coffee, an intermediate portion of the frame having a second shape could form with the lower portion a second volume corresponding to brewing two cups of coffee, and an upper portion of the frame 108 having a third shape could form with the lower portion and the intermediate portion a third volume corresponding to brewing three cups of coffee. Transitions between the first, second and third shapes would be characterised by various inflection points in the filter's lateral profile. It is also contemplated that the filter 100 could also include inscriptions on at least one of the top and bottom portions 102, 104 (examples of which being shown in FIG. 3) to indicate predetermined volumes of ground coffee, in addition to the visual shape changes of the filter.

Referring to FIGS. 5 and 6, a filter 100′ for the drip coffee machine 10 according to a second embodiment will be described. The filter 100′ has similarities with the filter 100, and common elements are provided with reference numbers with a prime sign ′.

The filter 100′ includes a hollow, substantially funnel-shaped body frame 108′. The body 101′ includes a generally oval top portion 102′ ended by an open top end 103′, and a bottom portion 104′ ended by a closed bottom end 105′. When the filter 100′ is disposed in the coffee machine 10, the top end 103′ is facing the water module 18.

The bottom portion 104′ includes two compartments 123′, 125′ (described below) and the filter 100′ such acts as a double brewing basket, having a first brewing basket 106a′ associated with the compartment 123′, and a second brewing basket 108b′ associated with the compartments 125′. As will be seen, the bottom portion 104′ of each compartments 123′, 125′ is recessed relative to the top portion 102′ of each compartments 123′, 125′. The top portion 102′ and the bottom portion 104′ of the filter 100′ in this embodiment have different shaped perimeters, or more specifically have different horizontal cross-sectional perimeters (or simply “perimeter”). The top and bottom portions 102′ and 104′ of each of the brewing baskets 108a1, 106b′ meet at a vertical location disposed between the open top end 103′ and the closed bottom end 105′ which defines an intermediate transition line T for each brewing baskets 106a′, 106b′. The intermediate transition line T defines the intersection between the top and bottom portions 102′ and 104′ of each brewing baskets 106a2′, 106b′ and creates a visually-identifiable demarcation for the user, similarly to the transition line T of the filter 100.

The body 101′ is made at least partially of a perforated filter material. In one embodiment, the body 101′ is made of a frame 108′ with various mesh portions covering windows defined in the frame 108′. The frame 108′ accepts a top mesh 110′ extending on the top portion 102′, and a bottom mesh (not shown) closing the bottom end 105′. Although the filter 100′ described herein includes a frame 108′ and meshes, if is contemplated that the meshes and frame could be integrally formed. The top mesh 110′ and the bottom mesh are made of metal and have a grid size allowing water to flow therethrough but retaining ground coffee. It is contemplated that the top mesh 110′ could be smaller or larger than shown in the Figures. It is also contemplated that the top mesh 110′ could be made of another suitable material. The top mesh 110′ is supported by a plurality of reinforcement arms 114′ of the frame 108′. The reinforcement arms 114′ are extending vertically on the top portion 102′. The reinforcement arms 114′ are inclined slightly outwardly to give the filter 100 a generally tapered appearance and favour water dripping toward the bottom end 105′ toward the carafe 18. It is contemplated that the reinforcement arms 114′ could be more or less inclined than shown in the Figures, thereby imparting a more or less taper to the filter 100′. It is also contemplated that the frame 108′ could have only more or less reinforcement arms 114′ than shown in the Figures. It is also contemplated that the reinforcement arms 114′ could extend only partially from the top portion 102′ to the bottom portion 104′. For example, the reinforcement arms 114′ could extend from only one of the top portion 102′ and the bottom portion 104′ without reaching the other one of the top portion 102′ and the bottom portion 104′. If is contemplated that the bottom mesh could be supported by reinforcement arms, such as the reinforcement arms 118 of the filter 100. It is also contemplated that the bottom portion 104′ could be differently shaped and that the filter 100′ could include a transition portion such as the transition portion 118 of the filter 100.

The two compartments 123′, 125′ are spaced by gap 129′ and joined at juncture 130′. it is contemplated that the gap 128′ could be omitted. The compartments 123′, 125′ are divided by a dividing wall 127′ extending vertically in the top portion 102′. The dividing wall 127′ could be fixed, movable, such as pivotable or even removable. The filter 100′ thus acts as a double brewing basket, having a first brewing basket 108a′ associated with the compartment 123′, and a second brewing basket 106b′ associated with the compartments 125′. The filter 100′ thus allows brewing two different types of coffee or brewing materials at a same time. In this embodiment, each of the compartments 123′, 125′ has a tapered shape. It is contemplated that the compartments 123′, 125′ could have various shapes. For example, they could be round or square. The compartments 123′, 125′ could have a same shape or a different shape from each other. While the filter 100′ is shown herein with compartments 123′, 125′ and brewing baskets 106a′, 106b′ of same sizes, it is contemplated that one of the brewing baskets 106a′, 106b′ could be bigger than the other.

Referring more specifically to FIG. 6, the filter 100′ has a lateral profile P′ (illustrated by a thick black line). The lateral profile P′ is a line drawn from a profile or silhouette of a side of the filter 100′. The lateral profile P′ is determined on the filter 100′ as seen in a normal operating condition, such as the side elevation view in FIG. 6. For any orientation of the filter about a vertical V′, the filter 100′ has two lateral profiles, a left one Pleft′ and a right one Pright′.

The lateral profile P′ includes a top portion Ptop′, and a bottom portion Pbot′. The lateral profile P′ has a slope that undergoes at least one distinct change from the top end 103′ to the bottom end 105′. Slopes of the top portion Ptop′, and the bottom portion Pbot′ are in this embodiment generally constant, and the lateral profile P′ is characterised by one inflection point (i.e. clear slope change) at point P1′ which corresponds to the transition between the top portion 102′, and the bottom portion 104′, i.e. a location of the transition line T′ of the associated brewing baskets 106a′, 106b′. It is contemplated that one or some or all of the top portion Ptop′, and the bottom portion Pbot′ could be curved and that the slope may be identified as the tangent to the curve at the connection points between the portions Ptop, and Pbot.

The top portion Ptop′ and the bottom portion Pbot′ are laterally inwardly tapered and define a non-zero slope. The slope of the bottom portion Pbot′ is steeper than the slope of the top portion Ptop′, but it is contemplated that the top portion Ptop′ and the bottom portion Pbot′ could have various slopes with for example the top portion Ptop′ steeper than the bottom portion Pbot. It is also contemplated that the top portion Ptop′ and the bottom portion Pbot′ could have a same slope and that a transition portion similar to Ptrans in the filter 100 could have a different slope to enable visual identification of the bottom portion 104′ by having the bottom portion 104′ recessed relative to the top portion 102′.

It is contemplated that the lateral profile P could have only more than one inflection point. The inflection point is induced by a change of shape in the filter 100′ between the top portion 106′ and the bottom portion 104′. The change in the lateral profile P′ can also be characterised by a transition angle A1′ is defined between the top portion Ptop′ and the bottom portion Pbot′. The transition angle A1′ may be in one embodiment, between 90 and 170 degrees.

Each compartment 123′, 125′ of the bottom portion 104′ is designed to have a volume V0′ corresponding to a predetermined volume of ground coffee. In the embodiment shown in the figures the volume V0′ of each compartment 123′, 125′ corresponds to a single cup serving. Because of the change of shape between the circular top portion 102′ and the compartment 123′, 125′, the user easily recognizes what volume of the filter 100′ needs to be filled ground coffee to obtain a single cup of coffee. As a result, the user does not need to use a scoop that can hold a predetermined amount of ground coffee to transfer ground coffee to the filter 100′. The user can just transfer coffee with a regular spoon to the filter 100′ and fill the one or both compartment 123′, 125′ of ground coffee with the assurance that he/she will obtain a single serving of coffee. Should the user wanted a larger amount of coffee, for example, for a carafe, the user would then continue to fill the compartment(s) 123′, 125′ with ground coffee. A rest of the filter 100′ is available for added ground coffee. In one example, the filter 100′ holds enough ground coffee to brew a carafe of coffee. It is contemplated that the volume of ground coffee held by each compartment 123′, 125′ could correspond to amounts of coffee that will be other than a single cup of coffee. For example, each compartment 123′, 125′ could hold ground coffee for two cups of coffee. Similarly, the brewing baskets 106a′, 106b′ may hold more or less than coffee for making a carafe of coffee. If is contemplated that the top portion 102′ and the bottom portion 104″ could have a shape different from the one shown in the figures. For example, the top portion 102′ could be square and the bottom end 105′ could be circular. It is also contemplated that the top portion 102′ and the bottom end 105′ could have the same shape as long as there is a clear change of slope between the top portion 102′ and the bottom portion 104′. The lateral profile P′ may have at least one slope change which indicates the recess of the bottom portion 104′. FIGS. 7A to 7C show examples of filters (schematically shown) which profiles indicate such recess of the bottom portion and a transition line.

Because of the change of shape between the oval top end 103′ and the generally square bottom end 105′, the user easily recognizes what volume of the brewing baskets 106a′, 106b′ need to be filled ground coffee to obtain a single cup of coffee it is contemplated that the top portion 102′ and the bottom portion 104′ could have a shape different from the one shown in the figures. For example, the top portion 102′ could be square and the bottom portion 104′ could be circular, if is also contemplated that the top portion 102′ and the bottom portion 104′ could have the same shape yet different sizes.

Although the filter 100′ is shown herein to have only one portion (i.e. each compartment 123′, 125′) having a volume corresponding to a predetermined volume of coffee, it is contemplated that each brewing basket 106a′ 106b′ could have two or more of such portions, and as a result more than one changes of direction P1′. For example, the filter 100′ could have a lower portion of the frame having a first shape could have a first volume corresponding to a single cup of coffee, an intermediate portion of the frame having a second shape could form with the lower portion a second volume corresponding to brewing two cups of coffee, and an upper portion of the frame having a third shape could form with the lower portion and the intermediate portion a third volume corresponding to brewing three cups of coffee. Transitions between the first, second and third shapes would be characterised by various inflection points in the filter's lateral profile, it is also contemplated that the filter 100′ could also include inscriptions on at least one of the top and bottom portions 102′, 104′ to indicate predetermined volumes of ground coffee, in addition to the visual shape changes of the filter.

Turning now to FIGS. 8 and 9, a first embodiment of an adapter 200 for a filter 300 of the drip coffee machine 10 will now be described.

The filter 300 has a perforated surface (or mesh) 302 and having no physical delimitation (i.e. portions described above) therethrough to indicate a predetermined volume of coffee. The filter 300 has an open top end 307 and is closed at its bottom by bottom surface 308. When in use, coffee is placed in the filter 300, water is poured thereonto, and coffee drips through the bottom surface 308. The filter 300 shown herein has a cupcake shape, but it is contemplated that the filter 300 could have a different shape. For example, the filter could be conical. The filter 300 may be made of paper, be disposable or be made of mesh and reusable many times.

The adapter 200 is a removable add-in to the filter 300 so as to create a lower portion 304 of the filter 300 having a first volume V1 (upper limit shown in dotted lines). The volume V1 corresponds to a predetermined volume of coffee for brewing single cup of coffee. It is contemplated that the volume V1 could corresponds to sizes other than the brewing of one cup of coffee. For example, the volume V1 could correspond to two cups of coffee. To obtain a second volume of brewed beverage (a carafe for example), the user would fill the filter 300 with the adapter 200 in it until reaching about the top end 307 of the coffee filter 300. It is contemplated that the filter 300 could be designed such that the user would fill the filter 300 without the adapter 200 and reach about the top end 307 of the coffee filter 300 In order to brew the second volume of coffee. If is also contemplated that the user would not have to fill the coffee filter 300 until about the top end 307 (with or without the adapter 200 in it) in order to brew the second volume of coffee. It is contemplated that the filter 300 could be similar to the filter 100 and have a physical delimitation therethrough to indicate a predetermined volume of coffee and be useable with an adapter similar to the adapter 200 to create a second physical delimitation.

The adapter 200 is made of plastic and has an outside surface 202 mating the lower portion 304 of the filter 300. An inside surface 204 of the adapter 200 is circular and defines the volume V1. It is contemplated that the inside surface 204 could have a shape other than circular and still define the volume V1. For example, the inside surface 204 could be rectangular. The inside surface 204 is shown herein to be vertical, but it is contemplated that the inside surface 204 could be tapered. The adapter 200 has an upper surface 206, and a lower surface 208 in contact with the bottom 308 of the filter 300. Although the adapter 200 is shown herein to be plain, it is contemplated that the adapter 200 could be perforated similarly to the filter 300. It is also contemplated that the adapter 200 could define more than one volume. The inner surface 206 of the adapter 200 could include a step thereby defining two volumes (e.g. one cup and two cups) or brewed coffee.

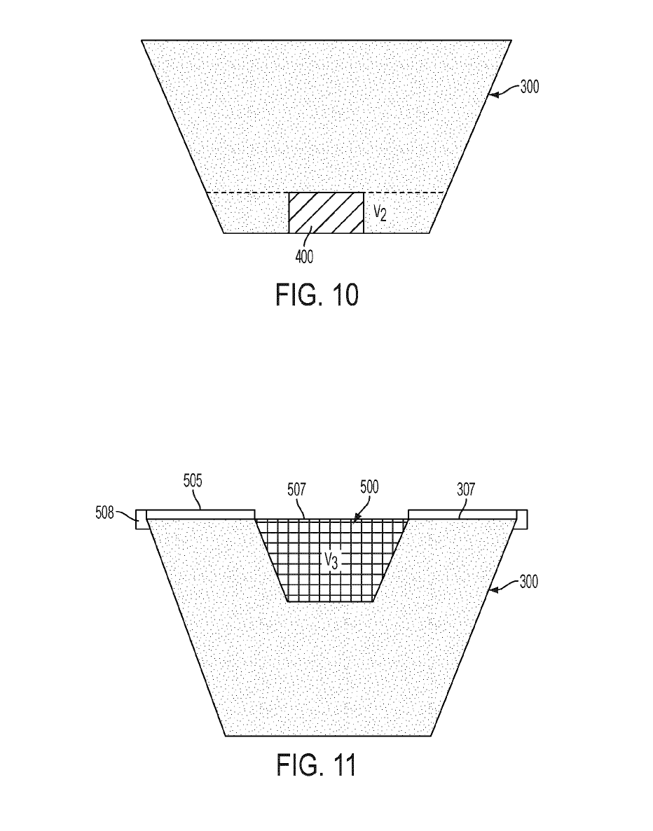

The adapter 200 could also have shapes other than the one shown in FIGS. 8 and 9. For example, as shown in FIG. 10, an adapter 400 according to a second embodiment has characteristics similar to the adapter 200, but is a pellet and does not mate with the filter 300. Coffee can be poured around the adapter 400 such that a volume V2 (upper limit shown in dotted lines) for brewing a predetermined amount of coffee (for example a single cup of coffee) is created between tine adapter 200 and the filter 300. It is contemplated that the adapter 400 could be perforated and could be a filter itself. Should the adapter 400 be perforated, the adapter 400 would be hollow and could have a lid to allow brewing material to be introduced inside the adapter 400. In such case, a volume of the adapter 400 would correspond to a volume for brewing a predetermined amount of coffee. It is also contemplated that the adapter 400 could also include inscriptions to indicate predetermined volumes of ground coffee.

Turning now to FIG. 11, a third embodiment of an adapter 500 will now be described.

The adapter 500 does not mate with the filter 300, instead, it is clipped to the top end 307 of the filter 300. The adapter 500 is perforated and acts as a filter itself. Its internal volume V3 corresponds to a volume for brewing a predetermined amount of coffee. The adapter 500 has an open top 507 onto which extend two pairs of arms 505 (only one pair being shown). The arms 505 connect to the top 307 of the filter 300 by clips 508. It is contemplated that the adapter 500 could be connected to the filter 300 by way other than the arms 505 and clips 508. For example, the adapter 500 could be connected directly to the filter 300 without the arms 505. Should one would want a second volume of brewed beverage which would be more than a single cup of coffee (a carafe for example), the user could fill the filter 300 without the adapter 500 in it until reaching a top 307 of the coffee filter 300.

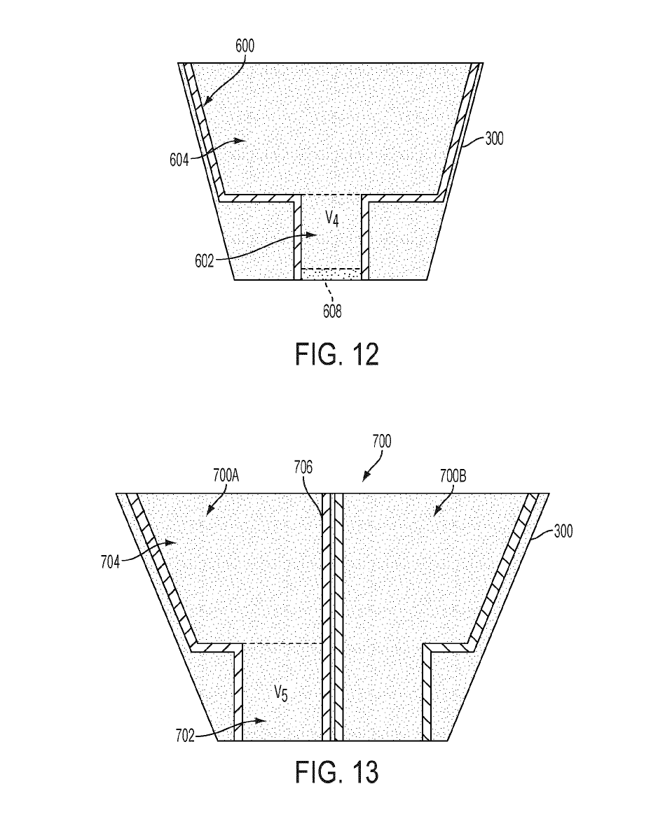

Turning now to FIG. 12, a fourth embodiment of an adapter 800 will now be described.

The adapter 600 is a two-part filter used in conjunction with the filter 300. The adapter 600 is made of a mesh, but it is contemplated that the adapter 600 could be plain. A lower portion 602 of the adapter 800 defines a first volume V4 (upper limit shown in dotted lines) corresponding to a volume for brewing a predetermined amount of coffee. An upper portion 604, together with the lower portion 602, defines a second volume for brewing a predetermined amount of coffee (larger than a single cup of coffee, a carafe for example). It is contemplated that the user could fill the filter 300 without the adapter 600 in it until reaching a top 307 of the coffee filter 300 to obtain the second volume. It Is also contemplated that a bottom of the filter 800 could be closed by a bottom wall 808 (shown in phantom). The bottom wall 608 may be plain or perforated, in the case where the adapter 600 is plain, the bottom wall 603 would be perforated. To use the adapter 600, the user first puts the adapter 600 inside the filter 300. The user then pours coffee grounds in the adapter 600 until the volume V4 has been filled in. When the adapter 600 has the bottom wall 608, the user may pour the ground coffee In the adapter 600 before the adapter 600 is inserted in the filter 300.

Turning now to FIG. 13, a fifth embodiment of an adapter 700 will now be described.

The adapter 700 is made of two adapter portions 700A and 700B. Each of the adapter portions 700A and 700B cooperate with each other to form two compartments of the adapter 700. That way, two sorts of coffees can be brewed at the same time in the adapter 700. The adapter 700B being a mirror image of the adapter 700A, only the adapter 700A will be described. The adapter 700A is a two-part adapter similar to the adapter 600 described above except that it occupies only half of the filter 300 so that the filter 300 can accept the adapter 700B. To this end, the adapter 700A has a vertical wall 706 abutting the adapter 700B.

The adapter 700A has a lower portion 702 defining a volume V5 (upper limit shown in dotted lines) corresponding to a volume for brewing a predetermined amount of coffee. An upper portion 704, together with the lower portion 702 defines a volume corresponding to a second volume of brewed beverage which would be more than a single cup of coffee (two cups for example). A bottom of the adapter 700A could be closed by a bottom wall similar to the bottom wall 608 so that the user may pour the ground coffee In the adapter 700A before the adapter 700A is inserted In the filter 300. The adapter 700A may be used with or without the adapter 700B disposed in the filter 300. The adapter 700A may be plain or perforated. When perforated, the adapter 700A may be designed to be used without the filter 300.

It is contemplated that the adapter 700 could be made of a single portion like the adapter 800 or the filter 100 and would have a fixed or removable wall therein (similar to the wall 706) to divide the adapter 700 Into two portions in order to brew two types of coffee at the same time.

Modifications and improvements to the above-described embodiments of the present may become apparent to those skilled in the art. The foregoing description is intended to be exemplary rather than limiting. The scope of the present is therefore intended to be limited solely by the scope of the appended claims.

1. A brewing filter for a drip coffee machine comprising:
a hollow, substantially funnel-shaped body defining therewithin a brewing cavity adapted to receive a brewing material the body being at least partially formed by a perforated filter material, the body having a top portion defining an open top end and a bottom portion including a closed bottom end of the filter, the bottom portion having a top end open to the top portion, the fop portion being perforated; and
the bottom portion and the top portion respectively defining bottom and top lateral profiles, the bottom lateral profile being laterally recessed relative to the top lateral profile, and a transition line located between the top and bottom portions forming a visually-identifiable demarcation within the brewing cavity.

2. The brewing filter of claim 1, further comprising an intermediate transition portion disposed between the top and bottom portions, the intermediate transition portion defining a transition lateral profile.

3. The brewing filter of claim 2, wherein the intermediate transition portion is stepped relative to at least one of the top portion and the bottom portion.

4. The brewing filter of claim 2, wherein each of the top, transition and bottom lateral profiles have different slopes.

5. The brewing filter of claim 2, wherein at least two of the top, bottom and transition lateral profiles intersect each other at an inflection point defining an angle therebetween.

6. The brewing filter of claim 5, wherein the angle is between 90 and 170 degrees.

7. The brewing filter of claim 1, wherein the top portion and the bottom portion have different perimeter shapes.

8. The brewing filter of claim 1, wherein the top and bottom lateral profiles are laterally inwardly tapered and define a non-zero slope.

9. The brewing filter of claim 1, wherein the top and bottom lateral profiles have different slopes.

10. The brewing filter of claim 1, wherein a volume of the brewing cavity defined within the bottom portion corresponds to a single-serving volume of ground coffee for brewing one cup.

11. The brewing filter of claim 1, the bottom portion includes two compartments forming two brewing chambers.

12. The brewing filter of claim 11, further comprising a dividing wall dividing the top portion and connecting to the bottom portion between the two compartments.

13. A drip coffee machine comprising:
a water module including:
a water reservoir; and
a heater heating adapted to heat water contained in the water reservoir;
a brewing module in fluid connection with the water module, the brewing module including:
a brewing filter including:
a hollow, substantially funnel-shaped body defining therewithin a brewing cavity adapted to receive a brewing material, the body being at least partially formed by a perforated filter material, the body having a top portion defining an open top end and a bottom portion including a closed bottom end of the filter, the bottom portion having a top end open to the top portion, the top portion being perforated; and
the bottom portion and the top portion respectively defining bottom and top lateral profiles, the bottom lateral profile being laterally recessed relative to the top lateral profile, and a transition line located between the top and bottom portions forming a visually-identifiable demarcation within the brewing cavity.

14. The drip coffee machine of claim 13, wherein the brewing filter is removable from the brewing module.

15. The drip coffee machine of claim 13, further comprising an intermediate transition portion disposed between the top and bottom portions, the intermediate transition portion defining a transition lateral profile.

16. The drip coffee machine of claim 15, wherein the intermediate transition portion is stepped relative to at least one of the top portion and the bottom portion.

17. The drip coffee machine of claim 15, wherein each of the top, transition and bottom lateral profiles have different slopes.

18. The drip coffee machine of claim 15, wherein at least two of the top, bottom and transition lateral profiles intersect each other at an inflection point defining an angle therebetween.

19. The drip coffee machine of claim 13, wherein a volume of the brewing cavity defined within the bottom portion corresponds to a single-serving volume of ground coffee for brewing one cup.

20. The drip coffee machine of claim 13, the bottom portion includes two compartments forming two brewing chambers.
